(19) United States
(12) Patent Application Publication
(10) Pub. No.: US 2018/0370139 A1
(43) Pub. Date: Dec. 27, 2018

(54) PACKAGED RESIN PRODUCTS FOR ADDITIVE MANUFACTURING

(71) Applicant: Carbon, Inc., Redwood City, CA (US)

(72) Inventor: Matthew Panzer, Redwood City, CA (US)

(21) Appl. No.: 16/012,172

(22) Filed: Jun. 19, 2018

Related U.S. Application Data
(60) Provisional application No. 62/522,786, filed on Jun. 21, 2017.

(51) Int. Cl. B29C 64/314; B29C 64/106; B29C 64/371

(52) U.S. Cl. CPC B29C 64/314; B33Y 40/00; B29C 64/371; B29C 64/106

(57) ABSTRACT

Resin products useful for making three-dimensional objects by additive manufacturing, as well as methods of making the same, and of using the same, are provided. The resin products may include additional oxygen solubilized in a resin in addition to that amount of oxygen otherwise absorbed by the resin from the ambient atmosphere prior to or during packaging of the resin in a container, less nitrogen solubilized in the resin as compared to that amount of nitrogen otherwise absorbed by the resin from the ambient atmosphere prior to or during packaging of the resin in a container, or both.

### FIELD OF THE INVENTION

The present invention concerns additive manufacturing, and particularly concerns packaged resin products for additive manufacturing, and methods of making and using such products.

### BACKGROUND OF THE INVENTION

Some additive manufacturing techniques, particularly bottom-up and top-down stereolithography, make a three-dimensional object by light polymerization of a resin (see, e.g., U.S. Pat. No. 5,236,637 to Hull). Unfortunately, such techniques have been generally considered slow, and have typically been limited to resins that produce brittle or fragile objects suitable only as prototypes.

A more recent technique known as continuous liquid interface production (CLIP) allows both more rapid production of objects by stereolithography (see, e.g., J. Tumbleston et al., Continuous liquid interface production of 3D Objects, Science 347, 1349-1352 (16 Mar. 2015) and U.S. Pat. Nos. 9,205,601; 9,211,678; 9,216,546; 9,360,757; and U.S. Pat. No. 9,498,920 to DeSimone et al.), and the production of parts with isotropic mechanical properties (see R. Janusziewcz et al., Layerless fabrication with continuous liquid interface production, Proc. Natl. Acad. Sci. USA 113, 11703-11708 (Oct. 18, 2016)).

Still further, the recent introduction of dual cure additive manufacturing resins by Rolland et al. (see, e.g., U.S. Pat. Nos. 9,676,963; 9,598,606; and 9,453,142), has additionally made possible the production of a much greater variety of functional, useful, objects suitable for real world use.

Together, these developments have created an increased demand for additive manufacturing resins and systems that allow the production of objects with a high degree of accuracy.

### SUMMARY OF THE INVENTION

In overview of the present disclosure, the dissolved gas content of polymerizable resins may be modified to enhance the quality, accuracy, and/or speed of production of additively manufactured objects. For example, oxygen may be depleted from the resin, as is customary for other categories of resins in which oxygen inhibits their polymerization. Alternatively, and counter-intuitively, oxygen may be added to the resin, to reduce capeing or otherwise enhance accuracy during additive manufacturing procedures such as CLIP. In addition to, or as an alternative to, decreasing or increasing oxygen content, nitrogen may be removed from the resin, to reduce cavitation and bubble-formation in parts during additive manufacturing (which events may otherwise limit the speed at which the objects can be made, or reduce part quality).

Adjustment of resin gas content can be advantageously carried out when the resin is being manufactured and packaged, and/or before or during dispensing of a resin into the build region of an additive manufacturing apparatus (e.g., onto the window or build surface of a bottom-up additive manufacturing apparatus, such as for continuous liquid interface production).

Accordingly, provided herein is a method of preparing a packaged resin product for use in the additive manufacturing of a three-dimensional object (e.g., by continuous liquid interface production), which may include: (a) providing an additive manufacturing resin in liquid form; then (b) (i) solubilizing additional oxygen into said resin in addition to that amount of oxygen absorbed by the resin from the ambient atmosphere, (ii) removing nitrogen from said resin absorbed by the resin from the ambient atmosphere, or (iii) both (i) and (ii); and (c) sealing said resin with said additional oxygen solubilized therein and/or nitrogen depleted therefrom in a gas-impermeable container.

In some embodiments, step (b) may include both solubilizing additional oxygen into said resin in addition to that amount of oxygen absorbed by the resin from the ambient atmosphere and removing nitrogen from said resin absorbed by the resin from the ambient atmosphere.

In some embodiments, step (b) and sealing step (c) are carried out by sealing said resin in said gas-impermeable container with a headspace in the container containing an oxygen enriched atmosphere and/or nitrogen depleted atmosphere, optionally under pressure.

In some embodiments, step (b) is carried out by placing said resin into an gas-impermeable container while under an enriched oxygen atmosphere and/or nitrogen depleted atmosphere, optionally under pressure.

In some embodiments, step (b) is carried out by contacting said resin to a semipermeable membrane, with the opposite side of said semipermeable membrane contacting an oxygen-enriched and/or nitrogen depleted fluid.

In some embodiments, the resin contains at least two, three, four or five times the amount of oxygen that would be absorbed by the resin from the ambient atmospheric air at a temperature of 20° C. and a pressure of 1 bar (that is, wherein said resin has an oxygen partial pressure enhanced from 0.21 bar to a partial pressure of oxygen of at least 0.42, 0.63, 0.84, or 1.05 bar at a temperature of 20° C.) (and up to 1, 2 or 3 atmospheres of pure oxygen, or more).

In some embodiments, the resin contains not more than 0.75, 0.5, 0.25, or 0 times the amount of nitrogen that would be absorbed by the resin from the ambient atmospheric air at a temperature of 20° C. and a pressure of 1 bar (that is, wherein said resin has an nitrogen partial pressure reduced from 0.79 bar to a partial pressure of nitrogen no more than 0.59, 0.39, 0.19, or 0.0 bar at a temperature of 20° C.).

In some embodiments, the resin comprises a one-pot resin or a precursor resin for a dual cure additive manufacturing resin.

Also provided is a resin product useful for making three-dimensional objects by additive manufacturing, which may include: (a) a first gas-impermeable container; (b) a first additive manufacturing resin in said first container; and (c) (i) additional oxygen solubilized in said first resin in addition to that amount of oxygen otherwise absorbed by the first resin from the ambient atmosphere prior to or during packaging of the first resin in the first container; (ii) less nitrogen solubilized in said first resin as compared to that amount of nitrogen otherwise absorbed by the first resin from the ambient atmosphere prior to or during packaging of the first resin in the first container, or (iii) both (i) and (ii).

In some embodiments, the container additionally contains a headspace, said headspace containing an oxygen-enriched and/or nitrogen-depleted gas, optionally under pressure.

In some embodiments, the first resin comprises a light polymerizable additive manufacturing resin (e.g., a precursor resin).

In some embodiments, the first resin comprises a first precursor resin for a light polymerizable additive manufacturing resin.

In some embodiments, the resin product may further include: (c) a second gas-impermeable container, (d) a second additive manufacturing resin in said second container; and (e) (i) additional oxygen solubilized in said second resin in addition to that amount of oxygen otherwise absorbed by the second resin from the ambient atmosphere prior to or during packaging of the second resin in the second container; (ii) less nitrogen solubilized in said second resin as compared to that amount of nitrogen otherwise absorbed by the second resin from the ambient atmosphere prior to or during packaging of the second resin in the second container, or (iii) both (i) and (ii); wherein said first and second resins when blended together produce a light polymerizable, dual cure, additive manufacturing resin.

In some embodiments, the resin(s) contains at least two, three, four or five times the amount of oxygen that would be absorbed by the resin from the ambient atmospheric air at a temperature of 20° C. and a pressure of 1 bar (that is, wherein said resin has an oxygen partial pressure enhanced from 0.21 bar to a partial pressure of oxygen of at least 0.42, 0.63, 0.84, or 1.05 bar at a temperature of 20° C.) (and up to 1, 2 or 3 atmospheres of pure oxygen, or more).

In some embodiments, the resin(s) contain not more than 0.75, 0.5, 0.25, or 0 times the amount of nitrogen that would be absorbed by the resin from the ambient atmospheric air at a temperature of 20° C. and a pressure of 1 bar (that is, wherein said resin has an nitrogen partial pressure reduced from 0.79 bar to a partial pressure of nitrogen no more than 0.59, 0.39, 0.19, or 0.0 bar at a temperature of 20° C.).

Further provided is a method of making a three-dimensional object from a light polymerizable polymerizable resin by contacting the polymerizable resin to an optically transparent window (optionally an oxygen-permeable window) in an amount sufficient to produce the object (optionally forming an oxygen-inhibited layer from said polymerizable resin on said window), and then producing an object from said polymerizable resin by continuous liquid interface production, the method including: (i) solubilizing additional oxygen into said polymerizable resin beyond that amount of oxygen absorbed by the polymerizable resin from the ambient atmosphere before placing the polymerizable resin on said window, (ii) removing nitrogen from said polymerizable resin that has been absorbed by the polymerizable resin from the ambient atmosphere before placing the polymerizable resin on said window, or (iii) both (i) and (ii).

In some embodiments, the resin contains at least two, three, four or five times the amount of oxygen that would be absorbed by the resin from the ambient atmospheric air at a temperature of 20° C. and a pressure of 1 bar (that is, wherein said resin has an oxygen partial pressure enhanced from 0.21 bar to a partial pressure of oxygen of at least 0.42, 0.63, 0.84, or 1.05 bar at a temperature of 20° C.) (and up to 1, 2 or 3 atmospheres of pure oxygen, or more).

In some embodiments, the resin contains no more than 0.75, 0.5, 0.25, or 0 times the amount of nitrogen that would be absorbed by the resin from the ambient atmospheric air at a temperature of 20° C. and a pressure of 1 bar (that is, wherein said resin has an nitrogen partial pressure reduced from 0.79 bar to a partial pressure of nitrogen no more than 0.59, 0.39, 0.19, or 0.0 bar at a temperature of 20° C.).

In some embodiments, the method may further include, after said resin is placed on said window, further (i) solubilizing additional oxygen into said polymerizable resin beyond that amount of oxygen absorbed by the polymerizable resin from the ambient atmosphere during or after placing the polymerizable resin on said window, (ii) removing nitrogen from said polymerizable resin that has been absorbed by the polymerizable resin from the ambient atmosphere during or after placing the polymerizable resin on said window, or (iii) both (i) and (ii) (e.g., by manipulation of the atmosphere applied on the opposite side of a gas permeable window).

In some embodiments, the method comprises a bottom-up stereolithography method, preferably continuous liquid interface production.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 schematically illustrates one embodiment of a process of the present invention.

FIG. 2 schematically illustrates one embodiment of a product of the present invention.

FIG. 3A is a photograph of a part produced from a resin that had not been pre-oxygenated. Note the presence of severe capeing.

FIG. 3B is a photograph of a part produced from a resin that had been pre-oxygenated. Note the substantial absence of capeing.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

“Capeing” as used herein refers to curing of a resin in unintended areas not intentionally exposed to the curing radiation during additive manufacturing.

### 1. Polymerizable Liquids (Resins).

Numerous resins for use in additive manufacturing are known and can be used in carrying out the present invention. See, e.g., U.S. Pat. No. 9,205,601 to DeSimone et al.

In some embodiments, the resin is a dual cure resin. Such resins are described in, for example, Rolland et al., U.S. Pat. Nos. 9,676,963; 9,598,606; and 9,453,142, the disclosures of which are incorporated herein by reference.

Resins may be in any suitable form, including “one pot” resins and “dual precursor” resins (where cross-reactive constituents are packaged separately and mixed together before use, and which may be identified, for example, as an “A” precursor resin and a “B” precursor resin).

Particular examples of suitable resins include, but are not limited to, Carbon, Inc. rigid polyurethane resin (RPU), flexible polyurethane resin (FPU), elastomeric polyurethane resin (EPU), cyanate ester resin (CE), epoxy resin (EPX), or urethane methacrylate resin (UMA), all available from Carbon, Inc., 1089 Mills Way, Redwood City, Calif. 94063 USA.

Note that, in some embodiments employing “dual cure” polymerizable resins, the part, following manufacturing, may be contacted with a penetrant liquid, with the penetrant liquid carrying a further constituent of the dual cure system, such as a reactive monomer, into the part for participation in a subsequent cure. Such “partial” resins are intended to be included herein. See, e.g., WO 2018/094131 (Carbon, Inc.), the disclosures of which are incorporated herein by reference.

In some embodiments, the resin(s) comprise a pseudoplastic composition having at least one solid particulate dispersed therein (e.g., wherein said solid particulate comprises (i) a reactive monomer or prepolymer (e.g., a polyamine), (ii) a filler (e.g., a toughener such as a core-shell rubber), or (iii) a combination thereof; e.g., wherein said solid particulate is included in said pseudoplastic composition in an amount of from 0.1, 0.2, 1, 2, 10, or 20 percent by weight, up to 40, 60, or 80 percent by weight, and/or wherein said solid particulate has an average diameter of from 1 or 2 micrometers up to 20 or 30 micrometers, or more).

### 2. Modification of Resin Gas Content and Packaged Resin Products.

In general, a method of preparing a packaged resin product for use in the additive manufacturing of a three-dimensional object may include the steps of: (a) providing an additive manufacturing resin in liquid form; then (b) (i) solubilizing additional oxygen into the resin in addition to that amount of oxygen absorbed by the resin from the ambient atmosphere, (ii) removing nitrogen from the resin absorbed by the resin from the ambient atmosphere, or (iii) both (i) and (ii); and (c) sealing the resin with the additional oxygen solubilized therein and/or nitrogen depleted therefrom in a gas-impermeable container.

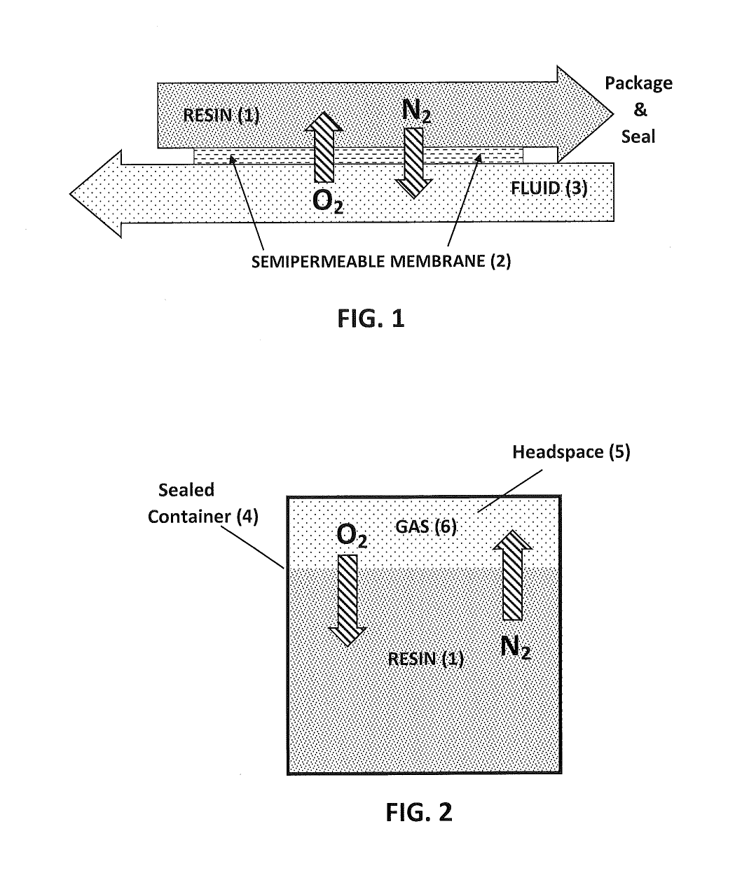

The gas manipulation may be carried out a variety of different ways. For example, the resin (1) may be contacted to a semipermeable membrane (2) in a gas exchange device (in continuous or batch fashion), with the opposite side of the semipermeable membrane (2) contacting an oxygen-enriched and/or nitrogen depleted fluid (3) (e.g., a gas), to add oxygen and/or deplete nitrogen, as schematically illustrated in FIG. 1. The resin may then be packaged in a gas-impermeable sealed container. In an additional example, dissolved gas in the resin may be manipulated by sealing the resin (1) in a gas-impermeable container to provide a sealed container (4) with a headspace (5) (e.g., 5, 10, 15 or 20 percent or more of the volume of the container empty of resin) in the container (4) containing an oxygen enriched atmosphere and/or nitrogen depleted atmosphere or gas (6), optionally under pressure, as schematically illustrated in FIG. 2. In a still further example, the enriching and/or depleting step may be carried out by packaging the resin into a gas-impermeable container while in or under an enriched oxygen atmosphere and/or nitrogen depleted atmosphere (e.g., in a glove box), optionally under pressure. Each of the foregoing may be carried out alone, or in combination with the other.

In some embodiments, the packaged resin contains at least two, three, four or five times the amount of oxygen that would be absorbed by the resin from the ambient atmospheric air at a temperature of 20° C. and a pressure of 1 bar (that is, wherein the resin has an oxygen partial pressure enhanced from 0.21 bar to a partial pressure of oxygen of at least 0.42, 0.63, 0.84, or 1.05 bar at a temperature of 20° C.) (and up to 1, 2 or 3 atmospheres of pure oxygen, or more).

In some embodiments, the packaged resin contains not more than 0.75, 0.5, 0.25, or 0 times the amount of nitrogen that would be absorbed by the resin from the ambient atmospheric air at a temperature of 20° C. and a pressure of 1 bar (that is, wherein the resin has an nitrogen partial pressure reduced from 0.79 bar to a partial pressure of nitrogen no more than 0.59, 0.39, 0.19, or 0.0 bar at a temperature of 20° C.).

As indicated above, the resin may comprises a one-pot resin (single or dual cure) for additive manufacturing, or a precursor resin for a dual cure additive manufacturing resin. When a two-part resin (two precursor resins that when blended together produce the dual cure resin) is used, they may both be provided in a separate container, as described above, and the containers packaged or otherwise joined together (e.g., in a dual cartridge; see, e.g., U.S. Pat. Nos. 5,685,846; 6,848,480; and 7,748,567).

### 3. Methods of Use.

Resin products as described herein above are useful for producing three-dimensional objects by by bottom-up or top-down stereolithography techniques, such as continuous liquid interface production (CLIP). Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, US Patent Application Publication No. 2013/0292862 to Joyce, and US Patent Application Publication No. 2013/0295212 to Chen et al. The disclosures of these patents and applications are incorporated by reference herein in their entireties.

As an example, top-down three-dimensional fabrication with a dual cure resin may be carried out by:

(a) providing a polymerizable liquid reservoir having a polymerizable liquid fill level and a carrier positioned in the reservoir, the carrier and the fill level defining a build region therebetween;

(b) filling the build region with a polymerizable liquid (i.e., the resin), said polymerizable liquid comprising a mixture of (i) a light (typically ultraviolet light) polymerizable liquid first component, and (ii) a second solidifiable component of the dual cure system; and then

(c) irradiating the build region with light to form a solid polymer scaffold from the first component and also advancing (typically lowering) the carrier away from the build surface to form a three-dimensional intermediate having the same shape as, or a shape to be imparted to, the three-dimensional object and containing said second solidifiable component (e.g., a second reactive component) carried in the scaffold in unsolidified and/or uncured form.

A wiper blade, doctor blade, or optically transparent (rigid or flexible) window, may optionally be provided at the fill level to facilitate leveling of the polymerizable liquid, in accordance with known techniques. In the case of an optically transparent window, the window provides a build surface against which the three-dimensional intermediate is formed, analogous to the build surface in bottom-up three-dimensional fabrication as discussed below.

As an example, bottom-up three-dimensional fabrication with a dual cure resin is carried out by:

(a) providing a carrier and an optically transparent member having a build surface, the carrier and the build surface defining a build region therebetween;

(b) filling the build region with a polymerizable liquid (i.e., the resin), said polymerizable liquid comprising a mixture of (i) a light (typically ultraviolet light) polymerizable liquid first component, and (ii) a second solidifiable component of the dual cure system; and then

(c) irradiating the build region with light through said optically transparent member to form a solid polymer scaffold from the first component and also advancing (typically raising) the carrier away from the build surface to form a three-dimensional intermediate having the same shape as, or a shape to be imparted to, the three-dimensional object and containing said second solidifiable component (e.g., a second reactive component) carried in the scaffold in unsolidified and/or uncured form.

In some embodiments of bottom-up or top-down three-dimensional fabrication as implemented in the context of the present invention, the build surface is stationary during the formation of the three-dimensional intermediate; in other embodiments of bottom-up three-dimensional fabrication as implemented in the context of the present invention, the build surface is tilted, slid, flexed and/or peeled, and/or otherwise translocated or released from the growing three-dimensional intermediate, usually repeatedly, during formation of the three-dimensional intermediate.

In some embodiments of bottom-up or top-down three-dimensional fabrication as carried out in the context of the present invention, the polymerizable liquid (or resin) is maintained in liquid contact with both the growing three-dimensional intermediate and the build surface during both the filling and irradiating steps, during fabrication of some of, a major portion of, or all of the three-dimensional intermediate.

In some embodiments of bottom-up or top-down three-dimensional fabrication as carried out in the context of the present invention, the growing three-dimensional intermediate is fabricated in a layerless manner (e.g., through multiple exposures or “slices” of patterned actinic radiation or light) during at least a portion of the formation of the three-dimensional intermediate.

In some embodiments of bottom-up or top-down three-dimensional fabrication as carried out in the context of the present invention, the growing three-dimensional intermediate is fabricated in a layer-by-layer manner (e.g., through multiple exposures or “slices” of patterned actinic radiation or light), during at least a portion of the formation of the three-dimensional intermediate.

In some embodiments of bottom-up or top-down three-dimensional fabrication employing a rigid or flexible optically transparent window, a lubricant or immiscible liquid may be provided between the window and the polymerizable liquid (e.g., a fluorinated fluid or oil such as a perfluoropolyether oil).

From the foregoing it will be appreciated that, in some embodiments of bottom-up or top-down three-dimensional fabrication as carried out in the context of the present invention, the growing three-dimensional intermediate is fabricated in a layerless manner during the formation of at least one portion thereof, and that same growing three-dimensional intermediate is fabricated in a layer-by-layer manner during the formation of at least one other portion thereof. Thus, operating mode may be changed once, or on multiple occasions, between layerless fabrication and layer-by-layer fabrication, as desired by operating conditions such as part geometry.

In some embodiments, the intermediate is formed by continuous liquid interface production (CLIP). CLIP is known and described in, for example, U.S. Pat. Nos. 9,205,601; 9,211,678; 9,216,546; 9,360,757; and U.S. Pat. No. 9,498,920 to DeSimone et al. In some embodiments, CLIP employs features of a bottom-up three-dimensional fabrication as described above, but the the irradiating and/or advancing steps are carried out while also concurrently maintaining a stable or persistent liquid interface between the growing object and the build surface or window, such as by: (i) continuously maintaining a dead zone of polymerizable liquid in contact with the build surface, and (ii) continuously maintaining a gradient of polymerization zone (such as an active surface) between the dead zone and the solid polymer and in contact with each thereof, the gradient of polymerization zone comprising the first component in partially-cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and potentially obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

Some aspects of the present invention are explained in greater detail in the non-limiting experimental section below.

### EXPERIMENTAL

Increasing the oxygen dissolved in the resin can increase the exposure required to gel the resin. This can have the benefit of improving part quality by reducing phenomenon related cure in unwanted areas due to the unattended propagation and scattering of light. These phenomena include cure through, over cure, capeing, etc.

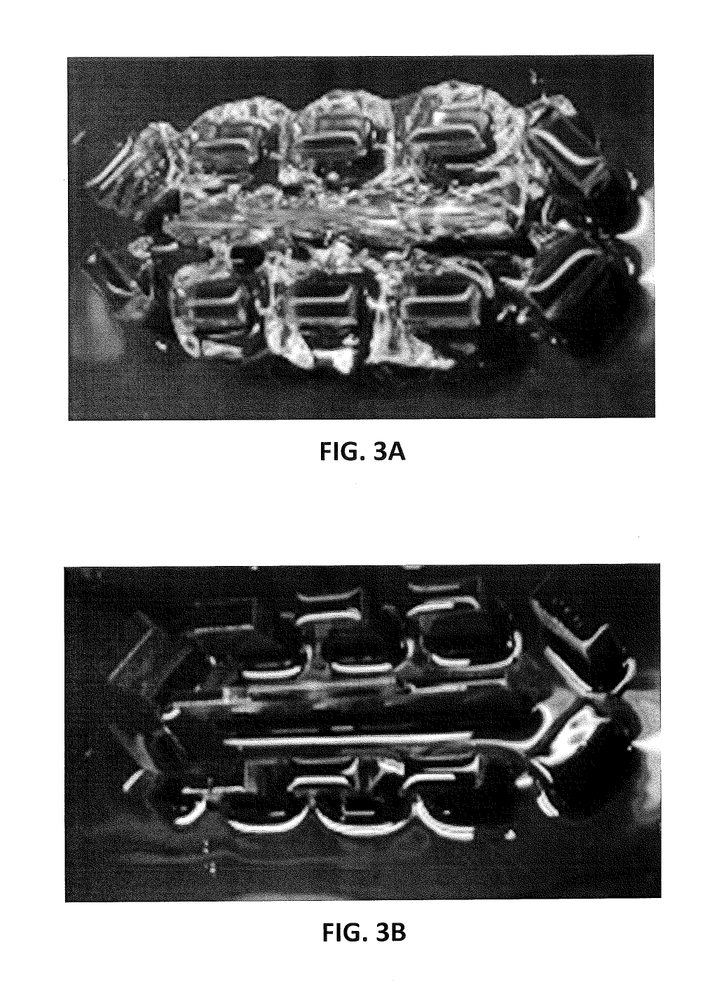

An experiment was performed in which the dissolved oxygen in a clear rigid polyurethane resin (RPU 70, available from Carbon Inc., 1028 Mills Way, Redwood City, Calif. 94063 USA) was increased up to a five times compared to the level equilibrated with air at atmospheric pressure, and a proportional (˜5×) increase in the exposure required to solidify the resin was observed. FIG. 3A-FIG. 3B show how this modification reduces capeing in otherwise similar parts, produced under conditions otherwise the same, on a Carbon M1 apparatus (available from Carbon Inc., 1028 Mills Way, Redwood City, Calif. 94063 USA) carrying out continuous liquid interface production, but where the part shown in FIG. 3A was produced from a resin that had not been pre-oxygenated, while the part shown in FIG. 3B was produced from a resin that had been pe-oxygenated.

Similar changes in dissolved oxygen content can modify the volumetric shrinkage of resins by comparable factors in addition to modifying mechanical properties.

Additional sensitivity studies have shown that a 0.01 atm increase in the equilibrium partial pressure of oxygen can reduce cure-through by four microns and lateral overcure by 3 microns, in at least some conditions.

These findings show that modifying and controlling the dissolved oxygen content in resins—not just at the dead zone, but in build region resin above the dead zone—can provide a way to improve part accuracy.

The foregoing is illustrative of the present invention, and is not to be construed as limiting thereof. The invention is defined by the following claims, with equivalents of the claims to be included therein.

That which is claimed is:

1. A method of preparing a packaged resin product for use in an additive manufacturing of a three-dimensional object, comprising:
(a) providing an additive manufacturing resin in liquid form; then
(b) (i) solubilizing additional oxygen into said resin in addition to that amount of oxygen absorbed by the resin from the ambient atmosphere, (ii) removing nitrogen from said resin absorbed by the resin from the ambient atmosphere, or (iii) both (i) and (ii); and
(c) sealing said resin with said additional oxygen solubilized therein and/or nitrogen depleted therefrom in a gas-impermeable container.

2. The method of claim 1, wherein said step (b) comprises both solubilizing additional oxygen into said resin in addition to that amount of oxygen absorbed by the resin from the ambient atmosphere and removing nitrogen from said resin absorbed by the resin from the ambient atmosphere.

3. The method of claim 1, wherein said step (b) and sealing step (c) are carried out by sealing said resin in said gas-impermeable container with a headspace in the container containing an oxygen enriched atmosphere and/or nitrogen depleted atmosphere, optionally under pressure.

4. The method of claim 1, wherein said step (b) is carried out by placing said resin into an gas-impermeable container while under an enriched oxygen atmosphere and/or nitrogen depleted atmosphere, optionally under pressure.

5. The method of claim 1, wherein said step (b) is carried out by contacting said resin to a semipermeable membrane, with the opposite side of said semipermeable membrane contacting an oxygen-enriched and/or nitrogen depleted fluid.

6. The method of claim 1, wherein said resin contains at least two times the amount of oxygen that would be absorbed by the resin from the ambient atmospheric air at a temperature of 20° C. and a pressure of 1 bar (that is, wherein said resin has an oxygen partial pressure enhanced from 0.21 bar to a partial pressure of oxygen of at least 0.42 bar at a temperature of 20° C.) (and up to 3 atmospheres of pure oxygen, or more).

7. The method of claim 1, wherein said resin contains not more than 0.75 times the amount of nitrogen that would be absorbed by the resin from the ambient atmospheric air at a temperature of 20° C. and a pressure of 1 bar (that is, wherein said resin has an nitrogen partial pressure reduced from 0.79 bar to a partial pressure of nitrogen no more than 0.59 bar at a temperature of 20° C.).

8. The method of claim 1, wherein said resin comprises a one-pot resin or a precursor resin for a dual cure additive manufacturing resin.

9. A resin product useful for making three-dimensional objects by additive manufacturing, comprising;
(a) a first gas-impermeable container;
(b) a first additive manufacturing resin in said first container; and
(c) (i) additional oxygen solubilized in said first resin in addition to that amount of oxygen otherwise absorbed by the first resin from the ambient atmosphere prior to or during packaging of the first resin in the first container; (ii) less nitrogen solubilized in said first resin as compared to that amount of nitrogen otherwise absorbed by the first resin from the ambient atmosphere prior to or during packaging of the first resin in the first container, or (iii) both (i) and (ii).

10. The product of claim 9, wherein said container additionally contains a headspace, said headspace containing an oxygen-enriched and/or nitrogen-depleted gas, optionally under pressure.

11. The product of claim 9, wherein said first resin comprises a light polymerizable additive manufacturing resin.

12. The product of claim 9, wherein said first resin comprises a first precursor resin for a light polymerizable additive manufacturing resin.

13. The product of claim 12, further comprising:
(d) a second gas-impermeable container,
(e) a second additive manufacturing resin in said second container; and
(f)(i) additional oxygen solubilized in said second resin in addition to that amount of oxygen otherwise absorbed by the second resin from the ambient atmosphere prior to or during packaging of the second resin in the second container; (ii) less nitrogen solubilized in said second resin as compared to that amount of nitrogen otherwise absorbed by the second resin from the ambient atmosphere prior to or during packaging of the second resin in the second container, or (iii) both (i) and (ii);
wherein said first and second resins when blended together produce a light polymerizable, dual cure, additive manufacturing resin.

14. The product of claim 9, wherein said resin contains at least two times the amount of oxygen that would be absorbed by the resin from the ambient atmospheric air at a temperature of 20° C. and a pressure of 1 bar (that is, wherein said resin has an oxygen partial pressure enhanced from 0.21 bar to a partial pressure of oxygen of at least 0.42 bar at a temperature of 20° C.) (and up to 3 atmospheres of pure oxygen, or more).

15. The product of claim 9, wherein said resin contains not more than 0.75 times the amount of nitrogen that would be absorbed by the resin from the ambient atmospheric air at a temperature of 20° C. and a pressure of 1 bar (that is, wherein said resin has an nitrogen partial pressure reduced from 0.79 bar to a partial pressure of nitrogen no more than 0.59 bar at a temperature of 20° C.).

16. In a method of making a three-dimensional object from a light polymerizable polymerizable resin by contacting the polymerizable resin to an optically transparent window in an amount sufficient to produce the object, and then producing an object from said polymerizable resin by continuous liquid interface production, the improvement comprising:
(i) solubilizing additional oxygen into said polymerizable resin beyond that amount of oxygen absorbed by the polymerizable resin from the ambient atmosphere before placing the polymerizable resin on said window, (ii) removing nitrogen from said polymerizable resin that has been absorbed by the polymerizable resin from the ambient atmosphere before placing the polymerizable resin on said window, or (iii) both (i) and (ii).

17. The method of claim 16, wherein said resin contains at least two times the amount of oxygen that would be absorbed by the resin from the ambient atmospheric air at a temperature of 20° C. and a pressure of 1 bar (that is, wherein said resin has an oxygen partial pressure enhanced from 0.21 bar to a partial pressure of oxygen of at least 0.42 bar at a temperature of 20° C.) (and up to 3 atmospheres of pure oxygen, or more).

18. The method of claim 16, wherein said resin contains no more than 0.75 times the amount of nitrogen that would be absorbed by the resin from the ambient atmospheric air at a temperature of 20° C. and a pressure of 1 bar (that is, wherein said resin has an nitrogen partial pressure reduced from 0.79 bar to a partial pressure of nitrogen no more than 0.59 bar at a temperature of 20° C.).

19. The method of claim 16, further comprising, after said resin is placed on said window, further (i) solubilizing additional oxygen into said polymerizable resin beyond that amount of oxygen absorbed by the polymerizable resin from the ambient atmosphere during or after placing the polymerizable resin on said window, (ii) removing nitrogen from said polymerizable resin that has been absorbed by the polymerizable resin from the ambient atmosphere during or after placing the polymerizable resin on said window, or (iii) both (i) and (ii).

20. The method of claim 16, wherein said method comprises a bottom-up stereolithography method, preferably continuous liquid interface production.
